(19) United States
(12) Patent Application Publication
(10) Pub. No.: US 2008/0128265 A1
(43) Pub. Date: Jun. 5, 2008

(54) Electrode Assembly and System

(75) Inventors: Danny O'Hare, Brighton (GB); Severin Luc Ramses Harvey, London (GB); Kim Howard Parker, London (GB)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: IMPERIAL INNOVATIONS LIMITED, London (GB)

(21) Appl. No.: 11/565,083

(22) Filed: Nov. 30, 2006

(51) Int. Cl. C25B 15/00; B05D 5/12; C25B 9/00; C25B 11/00

(52) U.S. Cl. 204/155; 204/279; 204/280; 204/293; 204/400; 427/117

(57) ABSTRACT

A sub-millimetre hydrogen collector generator ring disc electrode is disclosed which may be used in a collector generator system, for example for measurement of mass transport rates using hydrogen as a tracer. A calibrator and calibration method as well as a method of assaying tissue perfusion is also disclosed.

The present invention relates to a ring-disc electrode assembly for use as a hydrogen collector-generator electrode assembly and a corresponding system for measuring mass transport, as well as methods for operating, calibrating and using the system in particular, although not exclusively, for measuring tissue perfusion.

In physiology, tissue perfusion (TP) describes the movement of respiratory gases, nutrients and metabolites between the capillary bed and the cells. The exchange of gases and nutrients occurs from the capillaries to the cells and vice versa for the metabolites. TP is the mass transport mechanism which supports the cells' activities. A decrease in TP levels will compromise the cells ability to function properly. Poor TP is often attributed to pathological states in the vascular network such as blocked blood vessels (for example in heart failure or stroke).

In vital organs a decrease in TP will lead to death within minutes. In other parts of the body prolonged decrease becomes threatening to health. In both cases the tissue involved is said to be in shock. There are four classifications of shock depending on what causes it or what part of the body it affect (hypovolemic, cardiogenic, distributive and septic). The diseases associated with these are numerous and when they do not lead to death (ischemic heart disease, stroke, artery wall degradation etc), they result in great discomfort for the patients (arthritis, diabetes mellitus, wound healing, burns etc).

The collector-generator is an established electro chemical technique which is used for detecting and quantifying mass transport processes such as diffusion, convection, chemical reaction and migration (all of which are present in TP).

In one collector-generator system, a generator electrode generates hydrogen by electrolysis. A potential difference of less than or equal to the equilibrium potential used is generally applied to the generator electrode to favour hydrogen creation. A collector electrode collects the hydrogen from the solution by electrochemical oxidation. A potential difference more positive than the equilibrium potential is generally applied to the collector electrode to favour collection.

The collection of hydrogen at the collector electrode results in a concentration dependent current as is well understood by the person skilled in the art. As the local concentration of hydrogen will depend on mass transport processes in the vicinity of the electrodes due to tissue perfusion, the resulting variation in current can be used as a measure of tissue perfusion.

The hydrogen collector generator system is attractive for measuring tissue perfusion because it locally generates the tracer used for the measurement of mass transport and because hydrogen as a tracer is metabolically inert, diffuses rapidly in tissue and is removed rapidly from the blood by pulmonary circulation.

US444515 herewith incorporated by reference herein discloses a microelectrode collector generator system using two spaced platinum wires supported in fused glass capillaries for monitoring the perfusion rate of liquids or tissues. The current of the generator electrode is controlled to give a constant concentration of hydrogen at the collector electrode, thereby providing a measure of the perfusion rate: the higher the perfusion rate, the more current needs to be injected by the generator to generate sufficient hydrogen to keep the concentration at the collector constant.

Another approach to diffusion measurement is discussed in “Determination of Local Blood Flow (Microflow) by Electrochemically Generated Hydrogen”, K Stosseck, D W Lübbers and N Cottin, Pflügers Arch. 348, 225-238 (1974) herewith incorporated by reference herein. Stosseck et al also use two parallel wire electrodes but generate hydrogen tracer with a constant current and use the collector current as a measure of variations in the concentration of tracer.

A discussion of general background material relating to electrochemical methods including micro-electrodes and instrumentation can be found in “Electrochemical Methods: Fundamentals and Applications, second edition”, A J Bard, L R Faulkner, John Wiley & Sons, Inc. (2001), ISBN 0-471-04372-9 herewith incorporated by reference herein.

One disadvantage of the prior art arrangements discussed above is the directionality of the electrode assembly, the collector and generator being arranged side by side. When the perfusion includes a flow component, a minimum concentration reading is obtained for a given flow if the collector is upstream from the generator and a maximum reading is obtained if the collector is downstream from the generator. Thus, in order to make flow or perfusion measurements which are comparable between different measurement sites, the electrode assembly needs to be rotated into a pre-defined position, for example one where a maximum concentration reading is detected. This rotation of the electrode is cumbersome and prevents a quick and convenient measurement of diffusion where the electrode assembly is simply brought in contact with the measurement site and a reading is taken. Moreover, the definition and adjustment of the pre-defined measurement configuration could be expected to add to the measurement error and thus degrade the accuracy of measurement that can be achieved.

The invention is set out in the independent claims. Further, optional features are set out in the dependent claims.

In a first embodiment, there is provided a sub-millimeter diameter electrode assembly for electrochemically collecting and generating hydrogen having concentric ring and disc electrodes. By virtue of its concentric ring disc electrode layout, the measurement of the collector tracer concentration is independent of direction allowing the assembly to be used for measurement in any orientation.

The electrode assembly may include an insulated central conductor surrounded by an outer conductor. Hydrogen may be used as a tracer (see above for a discussion of the advantages using hydrogen in tissue perfusion measurements), in which case the electrodes include a material which is catalytic for a hydrogen electrode reaction. The material may include a platinum group metal, or a matrix material (such as carbon or a suitable inert material), which is modified with particles of a platinum group metal or alloy. For example, the material may be platinum. The electrode may include a central conductor which is a wire, which may be coated with polyester. The diameter of the disc electrode may be at a range of 5 to 300 micrometers, particularly 5 micrometers to 100 micrometers where it may be 25 micrometers or 50 micrometers. The thickness of the insulating layer separating the ring and disc electrodes may be in the range of 1 to 20 micrometers, particular 1 to 5 micrometer and the thickness of the ring electrode may be 0.5 micrometers to 10 micrometers and particularly 0.5 to 2 micrometers.

In a second embodiment, a mass transport measuring system for measurement of a mass transport rate in a aqueous medium using dissolved hydrogen as a tracer is provided. By using a ring-disc electrode assembly as defined above, the mass transport rate measurement is rendered direction independent and therefore more convenient and reproducible.

The system may include a calibrator for calculating a measure of mass transport, for example a mass transport rate constant or a local flow rate. The system may be operated in a continuous current mode where measurements are taken while the generator generates a constant amount of hydrogen. The calibrator may use the ratio of the collector to the generator current referred to below as Collection Efficiency (CE) in the calculations.

The system may be arranged to use either the ring or the disc as generator and the other one of the two electrodes as the collector. Alternatively, it may include a switch circuit operable to switch the generator from ring to disc. between the ring and the electrode with the generator.

In a third embodiment, there is provided a method of configuring a system as described above. Advantageously, the method provides for tuning the dynamic ranges and sensitivity of the system by selecting one of the electrodes for generating or by selecting the generator current as a function of the required dynamic ranges or sensitivity. The generator current may be increased in order to increase the sensitivity or decreased in order to increase the dynamic range and the sensitivity may be increased by selecting the disc electrode for generating while the dynamic range can be increased by selecting the ring electrode for generating.

In a fourth embodiment, there is provided a calibration chamber which includes an aqueous gel, foam or other porous medium filled chamber defining a conduit. Advantageously, the chamber allows for the consistent placement of the electrode assembly during calibration.

In a fifth embodiment, there is provided a method of calibrating a collector generator system. A measured current is calibrated to provide a measure of mass transport rate constant by comparing it to the mass transport rate constant determined using hydrogen wash in or wash out whereby the collector electrode is both used to measure the current of the collector generator assembly as well as a measure of the hydrogen concentration in the hydrogen wash in wash out. Advantageously, using the same electrode for these two measurements renders the calibration consistent and eliminates measurement errors due to the placement of the electrode. The calibration may be carried out in the tissue of a live animal or human whereby a pulse of hydrogen for the hydrogen wash in or wash out method can be applied in a respiratory gas mix.

In a sixth embodiment a surgical instrument, for example an endoscope or laparoscope probe, is provided. Advantageously, by using an electrode assembly as defined above, measurement of tissue perfusion during surgery is facilitated due to the directional independence of the electrode assembly.

In a seventh embodiment, there is provided a method of measuring tissue perfusion, for example as a method of assaying tissue health.

In an eighth embodiment, there is provided a method of making an electrode assembly having a ring and a disc electrode using an insulated wire. Advantageously, the insulated wire may be obtained as a commercial staple product.

Exemplary embodiments are now described by way of example only with reference to the accompanying figures in which:

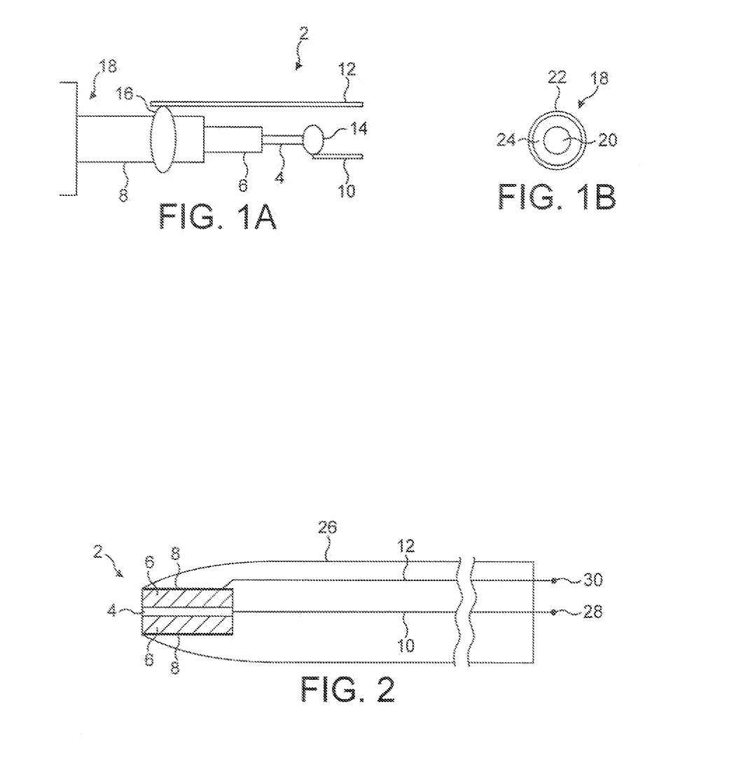

FIG. 1 depicts a ring disc assembly in accordance with the present invention;

FIG. 2 depicts an electrode holder;

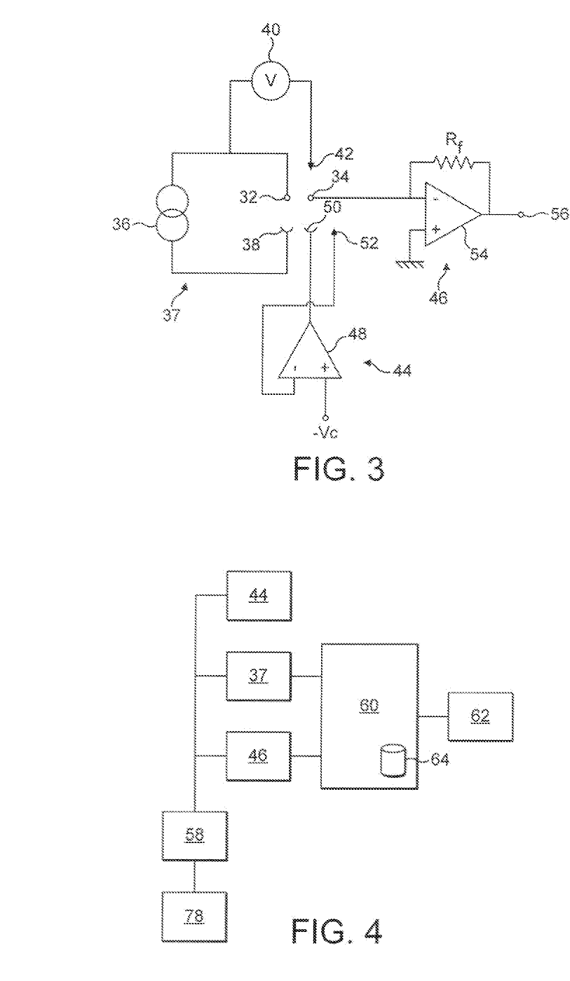

FIG. 3 depicts a driving and sensing circuit;

FIG. 4 depicts a mass transport rate measurement system;

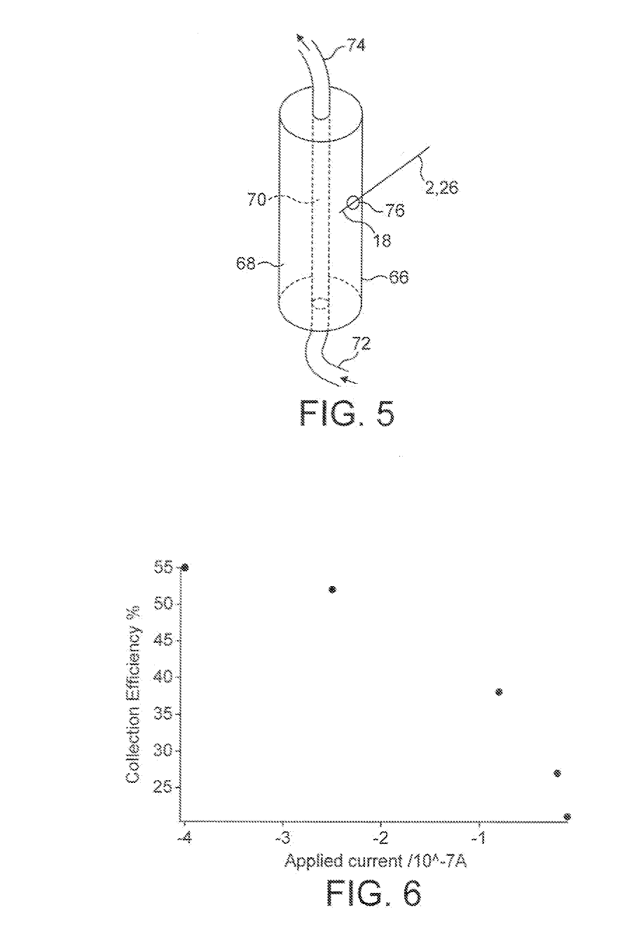

FIG. 5 depicts a calibration chamber;

FIG. 6 depicts a calibration curve;

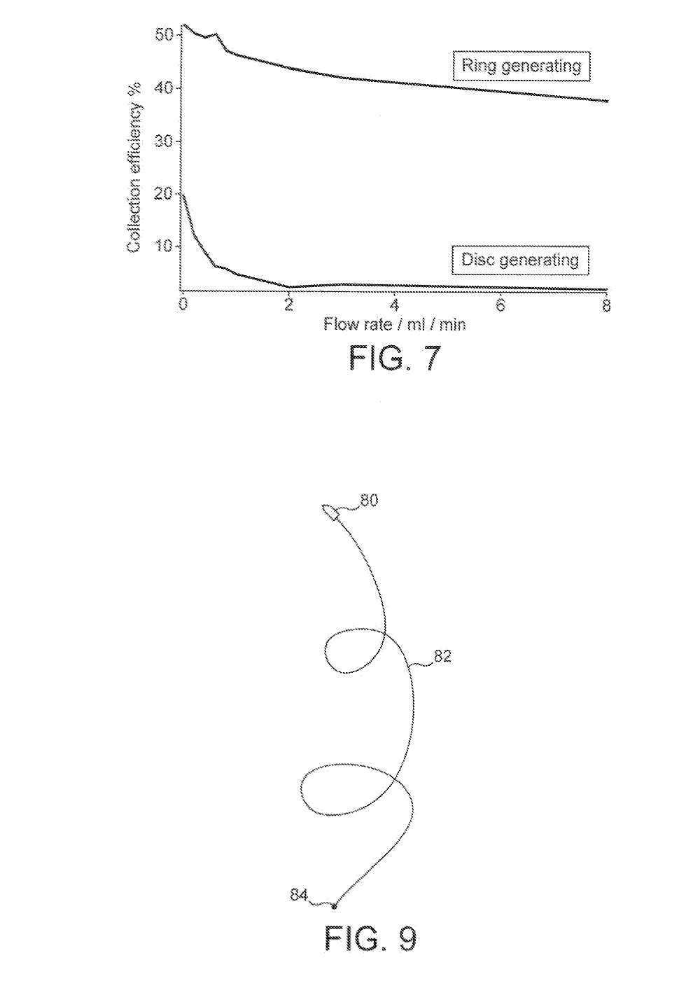

FIG. 7 depicts the variation of collection efficiency with increasing flow rate;

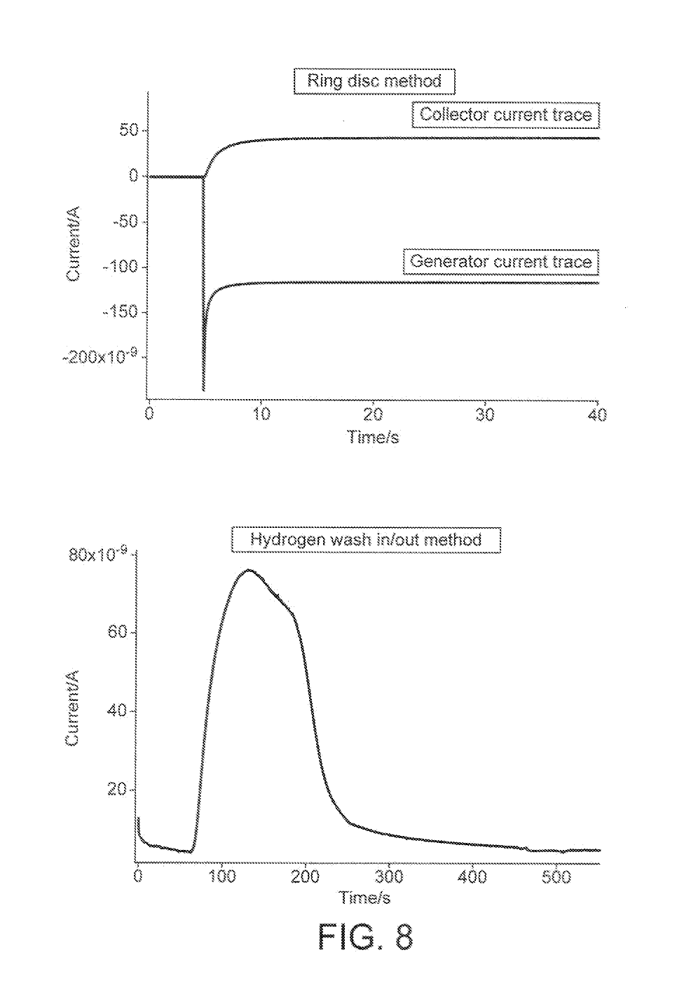

FIG. 8 depicts a comparison between the disclosed method and the prior rt hydrogen wash in method; and

FIG. 9 depicts an endoscopic probe.

With reference to FIG. 1, in one embodiment a ring disc microelectrode assembly 2 includes a central conductor 4, for example a platinum wire, coated by an insulating layer 6, which in turn is coated by a further, outer conductor 8, for example sputter coated platinum. Electrical connection wires 10 and 12 are connected to, respectively, the central conductor 4 and the further conductor 8 by connection means 14 and 16, for example silver epoxy paint. At the front end or tip 18 of the electrode assembly the central conductor 4 defines a central disc electrode 20 concentric with a ring electrode 22 defined by the outer conductor 8. The spacing between the two electrodes 20 and 22 is defined by the cross section 24 of the insulating layer 6.

Although the conductors 4 and 8 together with the insulator 6 define the electrodes 20 and 22 and the interspersed insulator region 24 in cross section, it is understood that they do not need to lie in the same plane. For example, the electrodes 20 and 22 may be protruding from the insulating region 24 or vice versa. Similarly, the conductors are not restricted to platinum wire for the central conductor and sputter coated platinum for the outer one but may include any combination of platinum, any platinum group metal, alloys thereof as well as an inter matrix material or a graphite matrix interspersed with particles of platinum, platinum group metals or alloys thereof. Where the electrode assembly is to be used for hydrogen generation and collection, conductors should be catalytic for a hydrogen electrode reaction, for example comprising materials as set out above. However, other applications with different tracer molecules may require different materials for the conductors. The insulator material may include any suitable insulating material, for example polyester which is advantageous for its break resistance. Other materials for example glass, are equally possible. The electrode assembly may also be manufactured with larger dimensions rather than as a micro-electrode assembly.

The electrode assembly 2 may be manufactured by depositing the outer conductor material, for example platinum on an insulated wire, for example platinum wire, which may be obtained commercially. Of course, the wire may be custom coated with the insulator. Any suitable deposition technique may be used, for example sputter coating. Other coating techniques which may be employed are evaporative coating, electroless deposition or ceramic or metal paint, for example. The dimensions of the ring electrode 20 are defined by the cross section of the inter conductor 4 and may range from 5 to 300 micrometer for the largest diameter, particularly 5 micrometer to 100 micrometer and for example 35 micrometers or 50 micrometers. Typically, the thickness of the insulating layer will be in the range from 1 to 20 micrometers, particularly 1 to 5 micrometers. The thickness of the ring electrode 22 (defined by the cross section of the outer conductor 8) will be in the range of 0.5 to 10 micrometers, particularly 0.5 to 2 micrometers. The resulting ring-disc electrode assembly thus has a diametre the sub-millimetre range, i.e. less than 1 mm.

For an electrode of this specification the applied current at the generator (either ring or disc generation mode) may be in the range 0 A or 0.1e-9A to 5e-4 A. A preferred operating range for the generator current is 1e-8A to 5e-7A

Also for an electrode of this specification a fixed voltage may be applied to the collector electrode of −0.2 V to +1.0 V vs Ag|AgCl, preferably 0 V to +0.3 V vs Ag|AgCl is applied, as described in more detail below.

Once a length of insulated wire has been coated, it can be cut into suitably sized length pieces, each piece providing an electrode assembly defining a ring and disc electrode at the cut surface. With suitable precision cutting, the electrode assemblies may be used straight away (subsequent to the attachment of suitable electric contacts as described with reference to FIG. 1 above) or the cut surfaces may be polished to plane the electrodes.

The electrode assembly's geometry, and, in particular, the dimensions of the electrodes may be tuned to control the volume probed by the electrode assembly. In order to increase the volume, the ring disc separation (i.e. the thickness of the insulator 6) may be increased. However, this may decrease the signal to noise ratio. In order to keep the volume probed large and maintain a good signal to noise ratio, the ring and disc areas (i.e. the disc diameter and ring thickness) may be increased together with the ring-disc separation. As the probe volume is increased in this way, the ratio of the edge of the electrodes to the area decreases, which may reduce the electrochemical edge effect which in turn may decrease mass transfer at the edge of the electrode thereby decreasing the electrode sensitivity. Thus, there is a trade-off between the volume that can be probed by the electrode assembly and the corresponding sensitivity.

Based on the above considerations, an upper limit of the total sensor diameter (the largest diameter of the ring 22) which can be expected to result in acceptable sensitivity is of the order of 300 μm for sensing physiological mass transport rates using hydrogen as a tracer, although the sensitivity benefits of small electrode size may extend up to a diameter of less than 1 mm, i.e. a sub-millimeter diameter. In practice, applications may require much smaller sensors. For example, an electrode assembly having a central conductor of 15 μm diameter, an insulating layer of 5 μm and an outer conductor layer of 2 μm probes a volume of approximately 1 mm³ (as determined by computer simulation), a size chosen to meet clinicians demands. Nevertheless, much smaller geometries down to approximately 10 micrometers may be possible.

Given the small dimensions of the electrode assembly, in practice it may be provided in an electrode holder to facilitate manipulation of the electrode assembly. For example, the electrode assembly 2 may be placed at the tip of a glass capillary 26 with the connections 10 and 12 terminating in respective connection terminals 28 and 30 at the other end of the glass capillary. To fix the assembly and connections in place, the capillary may be filled with a suitable material, for example and epoxy. It is also possible to use metal capillaries or hollow needles as holders

Alternatively, the sensor may comprise several rings of alternate concentric layers of insulator and conducting material applied onto the insulated wire. In this manner, it is possible to arrange all of the required electrodes. at the tip of the holder. The reference and counter electrodes must be in ionic electrical contact with both the collector and generator electrodes. In some applications, particularly in media of low ionic conductivity, it may be advantageous for the counter and reference electrodes to be packaged with the collector and generator electrodes. In most physiological applications, the conductivity of the tissue is sufficiently high to allow considerable flexibility in placement of the reference and counter electrodes which may be separate from the ring-disc electrode assembly of the sensor. It may be advantageous to use separate the counter electrodes from the sensor to minimise the risk of interference from counter electrode reaction products. Typically a separation of 10-50 working electrode diameters would be sufficient. The reference electrode or reference electrodes in this mode would be sufficiently close to the sensor to minimise voltage error.

Established lithographic methods may be used in fabrication in place of the method described above, as for example by Yamamoto K, Zeng H, Yi Shen, Ahmed M and Kato T. “Evaluation of an amperometric glucose biosensor based on a ruthenium complex mediator of low redox potential”, Talanta 66 (2005) pp 1175-1180 and by Sato K. et al., “Indirect amperometric detection of underivatized amino acids in microcolumn liquid chromatography with carbon film based ring-disk electrodes”, Analyst (2000), 125, pp 1041-1043, all herewith incorporated by reference herein, thus providing an embodiment whereby the disc, ring, reference and counter electrodes may be placed together on a single substrate.

With reference to FIGS. 3 and 4 a measurement system for measuring mass transport rates using the above described electrode assembly in a collector generator mode is described. Either the ring electrode 22 or disc electrode 24 can be used as a generator electrode for generating hydrogen in an aqueous solution with the other one of the two electrodes being used as a collector of hydrogen from the solutions. In contrast to rotating ring-disc systems, the electrode assembly is substantially stationary with regard to the medium, for example tissue, which is measured while measurements are being taken.

In FIG. 3 the generator electrode is schematically indicated by reference numeral 32 and the collector electrode is schematically indicated by reference numeral 34. The generator electrode 32 is supplied by a constant generating current from current source 36, the circuit being closed by counter electrode 38. The generating circuit 37 may further include an optional voltage measurement device 40 for measuring the voltage between generating electrode 32 and a reference electrode 32 and a reference electrode 42 in order to monitor the voltage resulting from the constant current, for example for detecting faults in the circuits. The constant current is arranged such that the potential of the generating electrodes 32 is at least less than E₀ for the generating reaction, that is less than −0.8 volts vs. Ag|AgCl. Typically, the current is selected such that the generating electrode is at a potential of less than −1.2 volts with respect to the aqueous medium surrounding the generator electrode.

The requirements of the control circuitry are to (i) control the collector electrode potential (ii) measure the collector current (iii) control either potential and current at the generator electrode (iv) record the generator electrode current. Control circuitry consists of potentiostatic or galvanostatic control of the generator electrode and potentiostatic control of the collector electrode. This can be achieved with well known standard circuit elements. For example, the collector electrode is controlled and read by a biasing circuit 44 and a sensing circuit 46. The biasing circuit 34 includes an operational amplifier 48 arranged to drive a counter electrode 50 to maintain the aqueous medium at −V_{c}, the negative of the collector electrode voltage as measured by reference electrode 52. The sensing circuit 56 includes an operational amplifier 54 collected in a negative feedback configuration to maintain the collector electrode 34 at virtual ground, thereby establishing a potential difference of V_{c} with respect to the aqueous medium. The collector potential V_{c} is set to a potential sufficiently large compared to the equilibrium potential of the collector reaction (E₀=0V) such that the rate of the collector reaction (and hence the collector current) is limited substantially only by the mass transport processes bringing hydrogen molecules within tunnelling distance (effectively in contact) of the collector electrode. In this regime, the i-v relationship of the collector is voltage independent and the reaction rate and the collector current depend substantially only on the concentration of hydrogen in the vicinity of the collector electrodes. In practice, a collector potential of +0.2 V vs. Ag|AgCl is typically found to be sufficient for this purpose.

In the above described arrangement the output 56 of the operational amplifier 54 of the sensing circuit 46 is indicative of the collector current i_{c}, which can be calculated as the output voltage measured at output 56 divided by the resistance of the feedback resistor R_{f}: −Vₒᵤₜ/R_{f}.

With reference to FIG. 4, a measurement system including the above described circuitry as well as control and analysis circuitry is now described. The generator circuit 37 and the biasing circuit 34 are controlled by control circuit 58. The generator driving circuit 37 and the sensing circuit 46 are arranged to produce respective outputs representative of the generator and collector current I_{g} and I_{c} which are fed into a calibrator 60. When the generating current is kept constant, the output representative of the generator current is constant and the calibrator may operate only on the collector current. Alternatively, the calibrator may calculate the collection efficiency (CE) for the collector generator, that is the ratio of the collector current to the generator current. The calibrator 60 then applies a calibration function, which may be stored in a database 64, to the generator current or collection efficiency to determine an output representative of a mass transport rate which is supplied to output device 62. The output may be representative of a mass transport rate constant or a local flow rate, as described in detail below.

Calibration of the above described measurement system is now described in detail with reference to FIGS. 5 to 8. FIG. 5 schematically depicts a calibration chamber for use with an electrode assembly in accordance with certain embodiments. A chamber 56 is filled with a gel, foam or other porous medium 68 such as to define a longitudinal channel 70 therethrough. An inlet 72 and an outlet 74 are connected to the channel such that a flow of liquid can be supplied to it. An aperture 76 in the wall of the chamber 68 allows the introduction of the electrode assembly 2 and the holder 26 through the aperture and into the gel 68 inside the chamber. By placing the tip 18 of the electrode assembly 2 inside the channel 70, the system can be calibrated for local flow rates as liquid flow having a controlled flow rate flows from inlet 72 past tip 18 to outlet 74. When the tip 18 is disposed within the gel 68, the system can be calibrated for a mass transport rate constant relating to diffusion within the gel 68 as described in more detail below.

In order to calibrate the collector current or collection efficiency for local flow rate, measurements of collection efficiency or collector current are obtained for a set of flow rates imposed on a calibration arrangement such as the one described above with reference to FIG. 5 to establish a functional relationship between the flow rate and measured quantities. Any suitable approach such as a look up table with or without interpolation, a polynomial approximation or other technique such as a neural network can be used to represent this function.

Similarly, in order to calibrate the measured quantity to derive a mass transport rate constant, measurements of current or collection efficiency can be paired with measurements of a mass transport rate constant using established techniques. For example, hydrogen wash-in or wash-out methods can be used to determine a mass transport rate constant or a measurement thereof.

Another calibration technique that may be used applies the principles of electrode reactions with coupled homogeneous chemical reactions (type EC, E stands for electrical reaction and C for chemical). In this calibration scheme the sensor is placed in a solution containing two species A and C. The reference and counter electrodes are placed in the same solution. The generator reacts with species A to form a new species B by application of a current or a voltage to the generator. The voltage at the collector is maintained such that it will collect the newly formed species B and convert it back to A. Species C is specifically selected such that it only reacts with species B to form a new species D. Species C thus competes with the collector for species B. This is analogous to tissue perfusion measurements where the hydrogen tracer will be absorbed by the vascular network in competition with the collector. Calibration is possible varying the concentration of species C or by using a range different compounds to represent species C. Thus for any given species C with a known and constant reaction rate constant, its concentration can be varied and correlated to collection efficiency. Alternatively, several different species C can be used at a known, fixed concentrations, in which case it is the difference in the reactions rate constants of each separate species that is correlated to collection efficiency.

An example of an EC mechanism taken from Albery & Hitchman (Ring-disc Electrodes, Oxford Univ Press, 1971) herewith incorporated by reference herein is;

A+e⁻ [symbol] B generator

B−e⁻ [symbol] A collector

Or

C+B [symbol] D in solution

Where A=Br⁻, B=Br₂, C=As(iii) and D=As(v)+2Br⁻

A further example of an EC reaction, from Bard & Faulkner (“Electrochemical Methods: Fundamentals and Applications, second edition”, A J Bard, L R Faulkner, John Wiley & Sons, Inc. (2001), ISBN 0-471-04372-9 herewith incorporated by reference herein), where the interfacial electrochemical reaction is followed by a coupled homogeneous chemical reaction is given below:

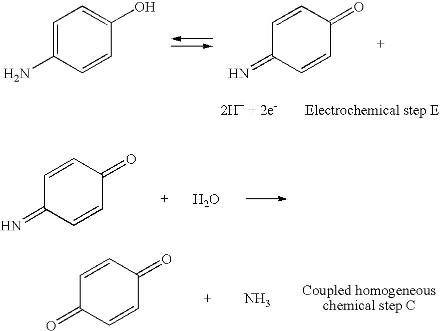

In applications of the measurement system as described above for measuring tissue perfusion, it would be desirable to follow the above calibration procedure in a human or animal subject, inserting the electrode arrangement into representative tissue and applying hydrogen to respiratory gases administered to the subject. This technique, known as hydrogen clearance can be used to derive values of blood flow through organs, as described in, for example “Transcutaneous hydrogen clearance—a new non-invasive technique for assessing blood flow in human skin”, Harrison, D K, Raad, R. A, Newton, D, McCollum P T, Physiol. Meas. 15 (1994), as well as US583029 or US5267569. As described above, a calibration function would be derived from pairs of measurements of collector current or collection efficiency and blood flow values derived using hydrogen clearance.

Advantageously, in calibration methods using hydrogen wash-in or wash-out or hydrogen clearance, the collector electrode can be used both for measuring the wash-in or wash-out or clearance as well as (at separate times) the collector current or collection efficiency when the generator is generating hydrogen. This allows for a highly consistent calibration procedure in which the positioning of the measuring electrode is kept constant between the two processes underlying the calibration.

A surprising and unexpected feature of embodiments of the present invention is that the sensitivity and dynamic range of the measurement system can be tuned by choosing whether to generate with the ring electrode or the disc electrode (using the other one of the pair for collecting) and by tuning the magnitude of the current supplied to the generating electrode. It is believed that this effect is related to the particular geometry of the electrode assembly.

With reference to FIG. 4, the measurement system may include a sensitivity and/or dynamic range selector 78 operatively connected to the controller 58 to operate the system such that the generating current is switched to the disc electrode if a higher sensitivity then presently available is required and to switch the generating current to the ring electrode if a higher dynamic range is required (consequently switching the other one of the two electrodes to the sensing circuit 46). Similarly, selector 78 and control circuit 58 are operable to increase the generating current if a higher sensitivity is required and to decrease it if an increased dynamic range is required. The sensitivity/dynamic range requirements may be input by a user using a user interface or may be determined automatically to configure the system on-line. It is also possible to configure the system once at the outset in which case selector 78 may not be required.

For the avoidance of doubt, sensitivity refers to the change in the measured signal for a change in the independent variable and dynamic range refers to the range of independent variables for which a measured signal can be reliably detected. Also, FIG. 4 depicts the system as an abstract schematic and the implementation of the functionally described elements may be in hard and/or software, using any suitable electronic components such as integrated circuits, relays and digital signal processors. The system may include a CPU and computer memory to support any software function as well as suitable input and output devices.

Sensitivity may be increased by increasing the applied current and/or using the disc for generating tracer. FIG. 6 depicts a disc generation calibration curve showing collection efficiency varying with applied generator current. The calibration curve spans high (4e-7) and low (1e-8) applied currents. It can be seen that sensitivity (collection efficiency) increases with increasing generator current. At low disc generator current the production of hydrogen tracer is distributed relatively uniformly over the surface of the disc and a significant proportion is lost by diffusion without being detected by the ring electrode. Sensitivity is thus low. At high generator current most tracer is generated at the periphery of the disc (closer to the ring) and a greater proportion diffuses to the ring, leading to a higher collection efficiency. Thus a range of different diffusion profiles and electrode sensitivities may be achieved by varying the generator current applied to the disc. This is also possible when the ring is the generator but to a lesser extent as the ring has a narrow cross section and the effect of the diffusion profile across its width is thus greatly reduced (see Fleischmann M., & Pons S., “The behaviour of micro-disk and micro-ring electrodes.” J. Electroanal, Chem., 222 (1987) pp 107-115 herewith incorporated by reference herein)

With reference to FIG. 7 (which shows the variation of collection efficiency with increasing flow rate in a 1 cm diameter pipe), the dynamic range of the sensor can be varied by choosing which of the ring or disc is to be used as the generator electrode. The dynamic range is larger but the sensitivity lower when using the ring to generate tracer. Conversely, with the disc generating the dynamic range is reduced but the sensitivity is higher. The dynamic range of the electrode assembly may also be extended by applying a lower generating current.

One advantage of embodiments of the invention over the hydrogen wash in-wash out method is the ability to make measurements continuously in real time. Previously known electrodes that use the hydrogen wash in-wash out method base their measurement on the time taken for externally introduced tracers to clear from the system and consequently require many minutes to determine a single reading. By generating small amounts of tracer locally which is rapidly cleared, the invention provided herein gives a near instantaneous reading of mass transport and enables continuous monitoring. FIG. 8 depicts a comparison of mas transport measurement made with the ring-disc electrode or a conventional electrode using the hydrogen wash in-wash out method, both measurements being conducted in a chamber of the type described above. The ring-disc electrode gives a reading after 5 seconds and which is continuously updated thereafter whereas the conventional electrode requires 400 seconds for the tracer ‘pulse’ to completely clear before a single reading is possible.

With reference to FIG. 9, in one exemplary application, the electrode assembly can be provided at a tip 80 of an endoscopic probe 82 which provides terminals 84 at an opposed end for connection to the remainder of the system. Advantageously, because of the isotropic geometry of the electrode assembly, the sensor can simply be inserted through the probe channel of the endoscope in place of, for example, a biopsy probe, without any adjustment of the sensor orientation being necessary. More generally, the electrode assembly may be provided at the operative end of surgical instruments to enable in situ measurements of tissue perfusion.

It is understood that other applications, in particular where monitoring tissue perfusion or tissue health, is required are also possible. In addition, applications other than monitoring tissue perfusion or tissue health are also envisaged and the electrode assembly and system described above could be used in any application which requires flow or mass transport measurements in an aqueous medium, for example chemical process monitoring or environmental flow measurements such as in riverbeds or sediments.

The above description is of a specific example only and numerous modifications are within the capabilities of the skilled person. For example, the electrode assembly may be manufactured using techniques other than described above and other control schemes than described above may be employed. For example, rather than using a constant current source for the generator current, a constant voltage source may be used. As a result, the generating current may fluctuate as a function of time. Correspondingly, the collector current may also vary as a function of time. A measure of collection efficiency could still be derived from sampling the currents at discrete times and dividing collector current by the generator current time sample by time sample, optionally followed by averaging.

The above exemplary description is thus not intended to limit the scope of the invention and other implementations and embodiments are within the scope of the following claims.

1. A sub-millimetre diameter electrode assembly for electrochemically collecting and generating hydrogen including a disc-shaped disc electrode concentric with an annular ring electrode and an insulator therebetween, the electrodes being catalytic for a hydrogen electrode reaction.

2. An electrode assembly as claimed in claim 1 in which the diameter is less than 300 μm.

3. An electrode assembly as claimed in claim 1, the electrodes including a platinum group metal, an alloy including a platinum group metal or a matrix material modified with particles of a platinum group metal or alloy.

4. An electrode assembly as claimed in claim 1 in which the insulator includes polyester.

5. An electrode assembly as claimed in claim 1 in which the diameter of the disc electrode is in the range of 5 to 300 μm, particularly 5 μm to 100 μm, 25 μm or 50 μm, the thickness of the insulating layer is in the range of 1 to 20 μm, particularly 1 to 5 μm and the thickness of the ring electrode is 0.5 μm to 10 μm, particular 0.5 to 2 μm.

6. An electrode assembly as claimed in claim 1 in which an electrical wire defines the disc electrode at one and thereof, an insulating layer surrounds the wire and a conducting layer surrounds the insulating layer to define the ring electrode.

7. An electrode assembly as claimed in claim 1, the electrodes being manufactured on a substrate by lithography

8. A mass transport measuring system for measuring a mass transport rate in an aqueous medium using dissolved hydrogen as a tracer, which includes a sub-millimeter diameter electrode assembly for electrochemically collecting and generating hydrogen including a disc-shaped disc electrode concentric with an annular ring electrode and an insulator therebetween and which further includes:
a biasing circuit operable to generate a potential difference V_{c} between a collector electrode and the aqueous medium to facilitate the collection of hydrogen from the aqueous medium;
a supply circuit connected to the generator electrode to facilitate the generation of hydrogen in the aqueous medium;
a sensing circuit operable to measure a collector current generated in the collector electrode as it collects hydrogen, wherein the collector electrode is one of the disc and ring electrodes and the generator electrode is the other one of the electrodes.

9. A system as claimed in claim 8 in which the supply circuit includes a constant current supply.

10. A system as claimed in claim 8 which includes a calibrator arranged to calculate a measure representative of a mass transport rate based on the output of the sensing circuit.

11. A system as claimed in claim 10 in which the measure is a mass transport rate constant.

12. A system as claimed in claim 10 in which the measure is a local flow rate.

13. A system as claimed in claim 10, in which the calibrator is arranged to calculate the measure using a ratio of the collector current to the generator current.

14. A system as claimed in claim 8 in which the sensing circuit is arranged to measure a collector current while the supply circuit supplies the generator current to the generator electrode.

15. A system as claimed in claim 8 in which the biasing circuit includes a first voltage follower for maintaining the aqueous medium at −V_{c} and a second voltage follower maintaining the collector electrode at ground, the sensing circuit measuring the output voltage of the second voltage follower to determine the collector current.

16. A system as claimed in claim 8 in which the generator electrode is the disc electrode.

17. A system as claimed in claim 8 in which the generator electrode is the ring electrode.

18. A system as claimed in claim 8 which includes a switch circuit operable to switch between the ring and disc electrodes for generating.

19. A system as claimed in claim 8 which includes a selector for selecting which electrode to use for generating or for selecting a supply current or both as a function of a required sensitivity or dynamic range of the system.

20. A system as claimed in claim 19 which is arranged to increase the generator current in order to increase the sensitivity or to decrease the generator current in order to increase the dynamic range.

21. A system as claimed in claim 19 which is arranged to select the disc electrode in order to increase the sensitivity or to select the ring electrode in order to increase the dynamic range.

22. A method of configuring a mass transport measuring system including an electrode assembly for electrochemically collecting and generating a tracer including a disc-shaped disc electrode concentric with an annular ring electrode and an insulator therebetween which method includes, for a required dynamic range or sensitivity of the electrode assembly, selecting the electrode used for generating as a function of the determined requirement or selecting a generator current supplied to one of the electrodes for generating as a function of the determined requirements.

23. A method as claimed in claim 22 which includes increasing the generator current in order to increase the sensitivity or to decrease the generator current in order to increase the dynamic range.

24. A method as claimed in claim 22 which includes selecting the disc electrode in order to increase the sensitivity or selecting the ring electrode in order to increase the dynamic range.

25. A calibration chamber for a collector generator electrode assembly including a cylindrical wall defining an aperture for accepting a front end of the electrode assembly, the chamber being filled with a gel or porous medium defining a longitudinal channel therein.

26. A method of calibrating a collector generator system including respective hydrogen and collector generator electrodes, the method including;
perfusing a volume adjacent to the electrodes with an aqueous solution;
externally applying a pulse of hydrogen to the aqueous solution and using the collector electrode to measure hydrogen wash-in or wash-out or clearance and determining a mass transport rate constant using the measurement;
measuring the collector current while the generator electrode generates hydrogen in the absence of externally applied hydrogen;
determining a calibration function to determine mass transport rate constant or blood flow and them measured current.

27. A method as claimed in claim 26 in which the electrodes are placed in a tissue of a subject and the externally applied hydrogen is applied in a respiratory gas mix to the subject.

28. A surgical instrument including an electrode assembly as claimed in claim 1 mounted at an operative end of the instrument.

29. A method of measuring tissue perfusion including contacting a tissue to be measured with a ring-disc electrode assembly; using the electrode assembly in a hydrogen collector-generator mode to generate and collect hydrogen in the tissue; and deriving a measure of tissue perfusion as a function of hydrogen collected.

30. A method of making an electrode assembly having a ring and disc electrode including coating an insulated wire with a conductor and cutting a length of the conductor coated insulated wire to define the electrodes at one end thereof.

31. A system as claimed in claim 8 in which the electrode assembly is substantially stationary with respect to the medium

32. A system as claimed in claim 8 in which the diameter of the electrode assembly is less than 300 μm.
